(19) United States
(12) Patent Application Publication
(10) Pub. No.: US 2017/0301418 A1
(43) Pub. Date: Oct. 19, 2017

(54) SALT COMPOSITIONS FOR MOLTEN SALT REACTORS

(71) Applicant: Elysium Industries Limited, Vancouver (CA)

(72) Inventors: Andrew Mccall Dodson, Boston, MA (US); Michael Forrest Simpson, Salt Lake City, UT (US); Edward Pheil, Delanson, NY (US); Michael E. Hanson, Clifton Park, NY (US)

(21) Appl. No.: 15/380,473

(22) Filed: Dec. 15, 2016

Related U.S. Application Data
(60) Provisional application No. 62/340,754, filed on May 24, 2016.
(60) Provisional application No. 62/269,525, filed on Dec. 18, 2015.
(60) Provisional application No. 62/340,762, filed on May 24, 2016.

(51) Int. Cl. G21C 3/54

(52) U.S. Cl. CPC G21C 3/54

(57) ABSTRACT

A salt composition for use as a fuel in a nuclear reactor is provided. The salt composition can include carrier salts having mixtures of one or more chloride salts or one or more chloride salts and one or more fluoride salts and fuel salts including one or more chloride salts. The carrier salts can include alkali and/or alkaline earth cations, while the fuel salts can include actinide cations. The salt composition has a lower melting temperature, less corrosive redox properties, and allows proliferation-safe retention of actinides and concurrent removal of some fission products, as compared to other salts employed in molten salt reactors. Optionally, the salt composition can include one or more metal halides for further decreasing the melting point and/or increasing the boiling point of the composition, thereby increasing the range of the liquid phase of the salt composition.

### CROSS-REFERENCE TO RELATED APPLICATIONS

This application claims the benefit of U.S. Provisional Application No. 62/269,525, filed Dec. 18, 2015, entitled “SALT COMPOSITION FOR MOLTEN SALT REACTOR,” US. Provisional Application No. 62/340,754, filed May 24, 2016, entitled “CHLORIDE AND FLUORIDE SALT COMPOSITION FOR MOLTEN SALT REACTOR,” and U.S. Provisional Application No. 62/340,762, filed May 24, 2015, entitled “SALT COMPOSITION WITH PHASE MODIFIERS FOR MOLTEN SALT REACTOR.” The entirety of each of the above-referenced applications is incorporated by reference in their entirety.

### FIELD

Systems, methods, and devices are provided for molten salt reactors and, in particular, salt compositions for use as fuel for molten salt nuclear reactors.

### BACKGROUND

The global demand for energy has largely been fed by fossil fuels. A dominant theme in supplying energy has been to take some form of reduced carbon out of the earth and burn it. However, those hydrocarbons are in limited supply and that basic energy supply paradigm is premised on a one-way stoichiometry in which hydrocarbons are burned to produce carbon dioxide. According to reports from the U.S. Environmental Protection Agency, more than 9 trillion metric tons of carbon is released into the atmosphere each year.

Nuclear power is appealing due to possibilities of abundant fuel and carbon-neutral energy production. Most nuclear energy has been provided using light water reactor (LWR) technologies utilizing solid fuel. Molten Salt Reactors (MSRs) may provide safety and cost advantages over LWRs. LWRs are more expensive to engineer and build than molten salt reactors (MSRs) because of heavy structural materials required to withstand the very high pressure in LWRs, and also require expensive containment systems to safeguard against accidents that can disperse radioactive material to the environment. Solid fuels contain their service lifetime of fission products and actinides with long-lived radioactive half-lives that must be contained within the solid fuel. Under some accident scenarios, the solid fuel can react with high temperature steam and/or air, resulting in failure of the mechanical integrity of the solid fuel. This failure can result in the subsequent release of fission products within the containment and, in a worst case scenario when containment is breached, out to the environment. Explosive hydrogen gas can also be produced from solid fuel reactions with steam and/or air during some accident scenarios, endangering the integrity of the containment system. LWRs with solid fuel have experienced some of these accidents.

### SUMMARY

In general, salt compositions for molten salt reactors are provided.

In an embodiment, a composition is provided that includes a carrier salt and a fuel salt. The carrier salt can include at least one chloride salt of an alkali or alkaline earth metal. The fuel salt can include at least one chloride salt of an actinide. The concentration of the fuel salt can be selected from the range of about 20 mole % to about 70 mole % of the composition and the composition can have a melting temperature less than or equal to 600° C.

The carrier and fuel salts can have a variety of configurations. In one embodiment, the carrier salt can include NaCl and CaCl₂.

In an embodiment, the fuel salt can include UCl₃. In an embodiment, the fuel salt can also include PuCl₃. In a further embodiment, the fuel salt can further include ThCl₄. In an additional embodiment, the fuel salt can additionally include one or more of PaCl₄, UCl₄, NpCl₃, AmCl₃, and CmCl₃. In another embodiment, the carrier salt can include NaCl and CaCl₂. The concentration of NaCl can be selected from the range of about 40 mole % to about 80 mole %. In another embodiment, the concentration of NaCl can be selected from the range of about 50 mole % to about 60 mole %. The concentration of CaCl₂ can be selected from the range of about 1 mole % to about 40 mole %. The concentration of CaCl₂ can be selected from the range of about 5 mole % to about 30 mole %. The concentration of the fuel salt can be selected from the range of about 20 mole % to about 50 mole %.

In another embodiment, the composition can include: NaCl in a concentration selected from the range of about 50 mole % to about 60 mole %; CaCl₂ in a concentration selected from the range of about 5 mole % to about 30 mole %; at least one actinide tri-chloride selected from the group consisting of: AmCl₃, CmCl₃, NpCl₃, PuCl₃, and UCl₃, where the total concentration of actinide tri-chlorides is selected from the range of about 40 mole % to about 60 mole %; and at least one actinide tetra-chloride selected from the group consisting of: UCl₄, PaCl₄, and ThCl₄, where the total concentration of actinide tetra-chlorides is selected from the range of about 2 mole % to about 10 mole %.

In another embodiment, the melting temperature of the composition can be between about 325° C. and about 500° C.

In another embodiment, the composition can include a plurality of metal halide phase modifiers. The plurality of metal halides can be selected from the group consisting of NbCl₅, TiCl₄, ZnCl₂, YCl₃, ZrCl₄, and AlCl₃. The total concentration of the phase modifier can be selected from the range of about 1 mole % to about 20 mole %.

In another embodiment, a composition is provided that includes a carrier salt and a fuel salt. The carrier salt can include a mixture of at least one chloride salt of an alkali or alkaline earth metal and at least one fluoride salt of an alkali or alkaline earth metal. The fuel salt can include at least one chloride salt of an actinide. The concentration of the fuel salt can be selected from the range of about 20 mole % to about 70 mole % of the composition and the composition can have a melting temperature less than or equal to 600° C.

The carrier salt and the fuel salt can have a variety of configurations. In an embodiment, the carrier salt can include NaCl, NaF, CaCl₂, and CaF₂.

In another embodiment, the fuel salt can include UCl₃. The fuel salt can additionally include PuCl₃. The fuel salt can also include ThCl₄. The fuel salt can further include one or more of PaCl₄, UCl₄, NpCl₃, AmCl₃, and CmCl₃.

In another embodiment, the carrier salt can include NaCl, NaF, CaCl₂, and CaF₂. The concentration of NaCl and NaF can be selected from the range of about 40 mole % to about 80 mole %. The concentration of CaCl₂ and CaF₂ can be selected from the range of about 50 mole % to about 60 mole %. The concentration of NaCl and NaF can be selected from the range of about 1 mole % to about 40 mole %. The concentration of CaCl₂ and CaF₂ can be selected from the range of about 5 mole % to about 30 mole %. The concentration of the fuel salt can be selected from the range of about 20 mole % to about 50 mole %.

In another embodiment, the composition can include: NaCl and NaF in a total concentration selected from the range of about 20 mole % to about 40 mole %; CaCl₂ and CaF₂ in a total concentration selected from the range of about 10 mole % to about 30 mole %; at least one actinide tri-chloride selected from the group consisting of: AmCl₃, CmCl₃, NpCl₃, PuCl₃, and UCl₃, where the total concentration of actinide tri-chlorides is selected from the range of about 40 mole % to about 60 mole %; and at least one actinide tetra-chloride selected from the group consisting of: UCl₄, PaCl₄, and ThCl₄, where the total concentration of actinide tetra-chlorides is selected from the range of about 2 mole % to about 10 mole %.

In another embodiment, the melting temperature of the composition can be between about 325° C. and about 500° C.

In another embodiment, the composition can include a plurality of metal halide phase modifiers. The metal halides can be selected from the group consisting of: NbCl₅, TiCl₄, ZnCl₂, YCl₃, ZrCl₄, and AlCl₃. The total concentration of the phase modifiers can be selected from the range of about 1 mole % to about 20 mole %.

### BRIEF DESCRIPTION OF THE DRAWINGS

Embodiments of the present disclosure can be more fully understood from the following detailed description taken in conjunction with the accompanying drawings, in which:

FIG. 1 is a pseudo-binary phase diagram for a representative salt composition of embodiments of the present disclosure illustrating melting temperature as a function of carrier salt concentration;

FIG. 2 is a schematic diagram illustrating a molten salt reactor system;

FIG. 3 is a schematic diagram illustrating a nuclear thermal generator plant;

FIG. 4 is a schematic diagram of a chemical processing plant; and

FIG. 5 is a flow diagram illustrating a method of preparing a composition for use as a nuclear fuel.

It is noted that the drawings are not necessarily to scale. The drawings are intended to depict only typical aspects of the subject matter disclosed herein, and therefore should not be considered as limiting the scope of the disclosure.

### DETAILED DESCRIPTION

Certain exemplary embodiments will now be described to provide an overall understanding of the principles of the structure, function, manufacture, and use of the systems, devices, and methods disclosed herein. One or more examples of these embodiments are illustrated in the accompanying drawings. Those skilled in the art will understand that the systems, devices, and methods specifically described herein and illustrated in the accompanying drawings are non-limiting exemplary embodiments and that the scope of the present invention is defined solely by the claims. The features illustrated or described in connection with one exemplary embodiment may be combined with the features of other embodiments. Such modifications and variations are intended to be included within the scope of the present invention. Further, in the present disclosure, like-named components of the embodiments generally have similar features, and thus within a particular embodiment each feature of each like-named component is not necessarily fully elaborated upon.

Embodiments of the disclosure provide salt compositions for use in molten form as nuclear fuel in nuclear systems including, but not limited to, molten salt reactors (MSRs). In general, MSRs can provide a variety of cost and safety advantages over conventional light water reactors (LWRs), which employ solid nuclear fuels. Examples of such advantages can include:
MSRs can operate at lower pressures and can possess higher heat capacity, allowing the use of containment vessels that are smaller and thinner, reducing the cost of containment.
Fission products generated during operation of MSRs can be removed in-service, rather accumulating between during shutdown periods. As a result, environmental risks arising from a worst case accident scenario (e.g., release of radioactive materials into the environment) can be reduced.
Molten fuel salts are generally non-reactive with the environment, reducing the likelihood of explosion in the event of a containment breach.
Fission products in molten fuel salts are chemically bound and physically frozen. Thus, the fission products are prevented from release if the molten salt leaks from the reactor.
In LWRs, solid fuels can melt and breach their containment in the event of a cooling failure. In contrast, molten fuel salts are in no danger of melting, since they are already in a molten form.
MSRs can employ passive safety features (e.g., walk-away safe emergency shutdown systems) that do not require operator action or electronic feedback to safely shut down operation in the event of an emergency.

Embodiments of the disclosed salt compositions can include mixtures of chloride salts or mixtures of chloride salts and fluoride salts. The component salts of the salt composition can be divided into two classes, referred to as carrier salts and fuel salts. The fuel salts contain one or more fissionable isotopes while the carrier salts serve as a solvent and coolant for transfer of heat generated by nuclear reaction of the fuel salts. One skilled in the art will appreciate that additional fission products generated during use of the salt, e.g., in the operation of a molten salt reactor, can also be present.

As discussed in detail below, in one embodiment, the salt composition can include carrier salts including mixtures of one or more chloride salts and fuel salts including one or more chloride salts. In another embodiment, the salt composition can include carrier salts having mixtures of one or more chloride salts and one or more fluoride salts and fuel salts including one or more chloride salts. The carrier salts can include alkali and/or alkaline earth cations, while the fuel salts can include actinide cations.

In further embodiments, the salt composition can optionally include one or more phase modifiers formed from metal halides. When added to the salt composition, it is expected that the phase modifiers can decrease the melting point and/or increase the boiling point of the salt composition, thereby increasing the range of temperatures over which the salt composition remains in the liquid phase. Examples of the phase modifiers that act to lower the melting point can include, but are not limited to, NbCl₅, TiCl₄, ZnCl₂, YCl₃, ZrCl₄, and AlCl₃. Furthermore, adding AlCl₃ to a salt composition containing NaCl can decrease the boiling point of the salt composition.

Although many metal halides, such as NbCl₅, TiCl₄, ZnCl₂, YCl₃, ZrCl₄, and AlCl₃ can be effective phase modifiers for embodiments of the salt composition, it can be preferable for a nuclear fuel to avoid an overly complex mixture of ions, which can create unpredictable or volatile species (e.g., volatile uranium species). Therefore, some embodiments of the salt composition can include only one of the phase modifiers.

The disclosed chloride and chloride/fluoride salt compositions can demonstrate attractive nuclear properties that address problems encountered with conventional salt compositions employed in MSRs. As an example, the nuclear, physical, thermal, and chemical properties of existing MSR systems using fluoride salts alone can be problematic. In one aspect, fluorine alone can be problematic in fast spectrum molten salt reactors, where the fission chain reaction is sustained by fast neutrons (e.g., neutrons having kinetic energy levels approaching 1 MeV or greater). The inelastic scattering cross-section of fluorine is significant with fast spectrum neutrons having energies down to about 100 keV. As a result, fission neutrons that are produced in the range of 1-5 MeV can be slowed through inelastic scattering with fluorine. Thus the peak fast flux most useful for directly fissioning a wide variety of actinides, such as in spent nuclear fuel, is reduced. In another aspect, fluoride salts tend to have a larger variation in viscosity and can require a larger thermal margin between the liquidus (melting) temperature and the minimum operating temperature of an MSR. As a result, the minimum operating temperature of the MSR may be elevated for salt compositions containing fluorine alone. Further discussion can be found in the following: Taube, 1978, Fast Reactors Using Molten Chloride Salts as Fuel, Final Report (1972-1977), Swiss Federal Institute for Reactor Research, Wurenlingen, CH (209 pages); Nelson et al., 1967, Fuel properties and nuclear performance of fast reactors fueled with molten chlorides, Nuclear Technology 3(9):540-547; and U.S. Pat. No. 8,506,855 to Moir, the contents of each of which are incorporated by reference in their entirety.

In contrast, the chloride and chloride/fluoride salt compositions of the present disclosure can address problems with melting temperature, cost, and redox potential. The melting temperature of the disclosed chloride and chloride/fluoride salts can be lower than equivalent fluoride salts. As an example, LiF—KF melts at 492° C., whereas LiCl—KCl melts at 353° C. The melting temperature of chloride/fluoride salt compositions can be even lower by taking advantage of the eutectic properties of mixed chloride and fluoride compositions. In general, an ideal molten salt has a melting temperature that is at least 100° C. below the operating temperature of the composition. Operating at a lower temperature increases the lifespan of the reactor, such as the steel jacket of the reactor core. Accordingly, the reduction in melting temperature allows the MSR to operate at lower temperature with an attendant reduction in operating cost. Additionally, the reduction potentials of metallic chlorides are significantly more coherent than fluorides across the group of the actinides, lanthanides, and alkaline/alkali-earth metals. Furthermore, actinide chlorides can become substituted with fluorine, producing actinide fluorides that are very stable and relatively insoluble in the carrier salts, potentially giving rise to precipitation of the actinide fluorides from the molten salt composition.

Specific compositions of the chloride salts and chloride/fluoride salts discussed herein can also exhibit other attractive nuclear properties. The actinide chloride fuel salts can allow MSRs to operate on lower enrichments of uranium (less than 20 mole % enriched because the concentration of the actinide salts can be higher), which are more proliferation-resistant. Furthermore, these fuel salts can allow for inclusion of natural uranium or thorium as fertile makeup fuel along with the potential consumption of plutonium or other actinides from spent nuclear fuel or weapons materials. The presence of thorium as a fertile fuel can result in the breeding of ²³²U, which can be considered as preventative of diversion of fissile material for weapons purposes due to the very strong gamma radiation produced by ²³²U decay daughters.

Embodiments of the carrier salts can include one or more chloride salts having alkali or alkaline-earth elements or mixtures of one or more chloride salts and one or more fluoride salts, each having alkali or alkaline-earth elements. The alkali elements are lithium (Li), sodium (Na), potassium (K), rubidium (Rb), cesium (Cs), and francium (Fr). The alkaline earth elements are beryllium (Be), magnesium (Mg), calcium (Ca), strontium (Sr), barium (B a), and radium (Ra). Examples of chloride salts can include, but are not limited to Na and Ca (e.g., NaCl and CaCl₂). Examples of mixtures of chloride salts and fluoride salts can include, but are not limited to, NaCl, NaF, CaCl₂, and CaF₂.

Embodiments of the fuel salts can include chloride salts having actinide cations. Suitable actinide isotopes can include fissile isotopes, which can undergo fission when absorbing neutrons, and fertile isotopes, which can yield a fissile isotope upon absorption of neutrons. Examples actinides can include one or more of thorium (Th), protactinium (Pa), uranium (U), neptunium (Np), plutonium (Pu), americium (Am), curium (Cm) (e.g., ²³²Pa, ²³³U, ²³⁵U, ²³⁷Np, ²³⁸Np, ²³⁹Pu, ²⁴¹Pu, ²⁴³Pu, ²⁴⁰Am, ²⁴²Am, ²⁴⁴Am, ²⁴³Cm, ²⁴⁵Cm, ²⁴⁷Cm), and fertile materials, such as ²³²Th, ²³⁸U, ²⁴⁰Pu, ²⁴²Pu. In certain embodiments, chloride actinides can include ²³³UCl₃, ²³⁵Ucl₃, ³²⁹PuCl₃, ²⁴¹PuCl₃, ²³⁷NpCl₃, ²³⁸NpCl₃, ²⁴⁰AmCl₃, ²⁴²AmCl₃, ²⁴⁴AmCl₃, ²⁴³CmCl₃, ²⁴⁵CmCl₃, ²⁴⁷CmCl₃, ²³²ThCl₄, ²³²PaCl₄, ²³³UCl₄, ²³⁵UCl₄, alone or in any combination. A person of skill in the art will appreciate that, when reference to an actinide omits the mass number, such reference can include any suitable isotope of the actinide.

Embodiments of the salt composition can include one or more carrier salts and one or more fuel salts, as discussed above. In certain embodiments, the salt composition can include a combination of at least NaCl, CaCl₂ as the carrier salt and at least one of PuCl₃, UCl₃, UCl₄, and ThCl₄ as the fuel salt. In further embodiments, the salt composition can exhibit a melting temperature less than or equal to about 600° C. In additional embodiments, the composition can exhibit a melting temperature within the range from about 325° C. to about 500° C. Optionally, the composition can further include one or more phase modifiers that serve to reduce the melting temperature.

In an embodiment, the salt composition can be a mixture of chloride salts as follows:
A chloride carrier salt including NaCl and CaCl₂. The concentration of NaCl can be selected from the range of about 40 mole % to about 80 mole % (e.g., about 50 mole % to about 60 mole %). The concentration of CaCl₂ can be selected from the range of about 1 mole % to about 40 mole % (e.g., about 5 mole % to about 30 mole %).
A fuel salt including at least one chloride having an actinide cation in a +3 or +4 oxidation state. Examples of such actinide chlorides can include, but are not limited to, AmCl₃, CmCl₃, NpCl₃, PuCl₃, UCl₃, UCl₄, PaCl₄, and ThCl₄. The total concentration of AmCl₃, CmCl₃, NpCl₃, PuCl₃, and UCl₃ can be selected from the range of about 20 mole % to about 50 mole % (e.g., about 25 mole % to about 35 mole %). The total concentration of UCl₄, PaCl₄, and ThCl₄ can be selected from the range of about 0 to about 20 mole % (e.g., 2 mole % to about 10 mole %).
In certain embodiments, the salt composition can include about 30 mole % NaCl, about 30 mole % CaCl₂, and about 40 mole % UCl₃. In other certain embodiments, the salt composition can include about 25 mole % NaCl, about 25 mole % CaCl₂, about 40 mole % UCl₃, and about 10 mole % ThCl₄.
Optionally, the salt composition can also include a metal halide phase modifier. Examples of the metal halides can include, but are not limited to, NaCl₅, TiCl₄, ZnCl₂, YCl₃, ZrCl₄, and AlCl₃. The total concentration of all phase modifiers can be selected from the range of about 1 mole % to about 20 mole % (e.g., about 2 mole % to about 10 mole %).

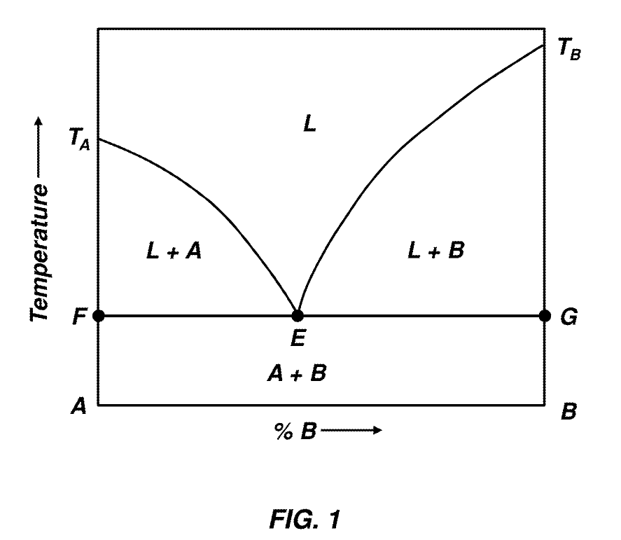

FIG. 1 illustrates a representative pseudo-binary phase diagram for a representative salt composition of the present disclosure. For example, compound A can be a first chloride salt of the carrier salt and compound B can be a second chloride salt of the carrier salt. The region labeled L indicates the temperatures where both A and B are in liquid form. The eutectic point is labeled E and the line FG indicates the lowest possible melting point for the composition. As shown in FIG. 1, the ratio of A and B within the composition can be varied to change the melting temperature, while the concentration of all fuel salts are held constant.

Notably, while uranium in the UCl₄ state (+4 oxidation state) can contribute to lowering the melting point of the eutectic, its electrochemical potential can lead to higher corrosion rates of the structural alloys forming various reactor components. In alternative embodiments, it is can be beneficial to replace uranium in the UCl₄ state with thorium in the ThCl₄ state, as the thorium salt can provide the salt composition with a comparable reduction in the melting point without the corrosive effects associated with UCl₄.

In another embodiment, the salt composition can be a mixture of chloride salts and fluoride salts as follows:
A carrier salt including NaCl, NaF, CaCl₂, and CaF₂. The combined concentration of NaCl and NaF can be selected from the range of about 40 mole % to about 80 mole % (e.g., about 50 mole % to about 60 mole %). The concentration of CaCl₂ and CaF₂ can be selected from the range of about 1 mole % to about 40 mole % (e.g., about 5 mole % to about 30 mole %).
A fuel salt including at least one chloride having an actinide cation in a +3 or +4 oxidation state. Examples of such actinide chlorides can include, but are not limited to, AmCl₃, CmCl₃, NpCl₃, PuCl₃, UCl₃, UCl₄, PaCl₄, and ThCl₄. The total concentration of AmCl₃, CmCl₃, NpCl₃, PuCl₃, and UCl₃ can be selected from the range of about 20 mole % to about 50 mole % (e.g., about 25 mole % to about 35 mole %). The total concentration of UCl₄, PaCl₄, and ThCl₄ can be selected from the range of about 0 to about 20 mole % (e.g., 2 mole % to about 10 mole %).
In certain embodiments, the salt composition can include about 30 mole % NaCl and NaF, about 30 mole % CaCl₂ and CaF₂, and about 40 mole % UCl₃. In other certain embodiments, the salt composition can include about 25 mole % NaCl and NaF, about 25 mole % CaCl₂ and CaF₂, about 40 mole % UCl₃, and about 10 mole % ThCl₄.
Optionally, the salt composition can also include a metal halide phase modifier. Examples of the metal halides can include, but are not limited to, NaCl₅, TiCl₄, ZnCl₂, YCl₃, ZrCl₄, and AlCl₃. The total concentration of all phase modifiers can be selected from the range of about 1 mole % to about 20 mole % (e.g., about 2 mole % to about 10 mole %).

The observations discussed above with respect to FIG. 1 regarding the ability of the chloride salts to reduce the melting point of the composition are also applicable to the combinations of chloride and fluoride salts as the carrier salts. It is anticipated that the fluoride ions can have a different effect than the chloride ions on the neutron spectrum (the population of the neutrons as a function of energy). For example, the fluoride ions can thermalize (slow down) the neutrons more than the chloride ions, which may increase the fission cross-section of the actinide fuel salts, decrease the breeding ratio, and increase the capture cross-section of other constituents in the salt composition.

It can also be desirable for the salt composition be tailored to avoid the corrosive properties of the constituent salt compounds as much as possible. An important consideration for salt compositions containing both chlorides and fluorides is to avoid fluorinating the fuel salt. For example, assuming the fuel salt is UCl₃, fluorination could result in UF₄⁻. The presence of UF₄⁻ can increase the melting temperature of the salt composition and is highly corrosive. Therefore, it is desirable to maintain fluoride levels within the salt composition as low as possible, while still optimizing the melting temperature.

In certain embodiments, the carrier salts can omit salts containing include lithium (Li), beryllium (Be), potassium (K), or magnesium (Mg). Unenriched Li can contain the isotope ⁶Li, a significant neutron poison, even in the fast spectrum. Both ⁷Li and Be can generate significant amounts of tritium (³H) from transmutation, which can contribute to radiation emissions at plant boundaries and increases the plant complexity and cost for tritium capture/retention. ³⁹K can absorb a neutron to become ⁴⁰K, which is a very long lived and radioisotope that emits high-energy gamma rays. Mg exhibits an electropotential that can interfere with electrochemical processes designed to retain actinides in the reactor system.

These difficulties can be avoided by the use of salt compositions including sodium and/or calcium. Sodium can absorb a neutron and transmute into stable magnesium, emitting both beta and gamma rays in the process. However, the half-life of this magnesium is only 9 hours and is not a long-lived waste product. Thus, it is not a deemed to be a concern, relative to fission product gamma emissions. Calcium has a “magic number” atomic mass, providing high stability with very little transmutation to very long lived gamma emitting isotopes.

It can be desirable to avoid changes to the salt composition that significantly increase the melting point. It may be preferable to substantially exclude Lithium and Potassium due to radioactivity of transmutation products. It can be preferable to include NaCl-CaCl₂ because of compatibility with UCl₃.

Embodiments of the disclosed salt compositions can be used as a fuel in any suitable nuclear system. Such nuclear systems can include, but are not limited to: critical and subcritical fission reactor systems such as molten-salt-fueled reactors, advanced “Generation IV” fission reactors, integral fast reactors; hybrid fusion-fission systems such as hybrid fusion-fission LIFE systems, other hybrid fission-fusion systems involving inertial-confinement fusion, and hybrid magnetic-confinement fission-fusion energy (MFE) systems; accelerator-driven nuclear systems; and any other application in which actinides are present in a high-temperature fluid. In preferred embodiments, the nuclear system is a fast-spectrum molten salt fueled nuclear thermal (heat) generator plant (NTGP).

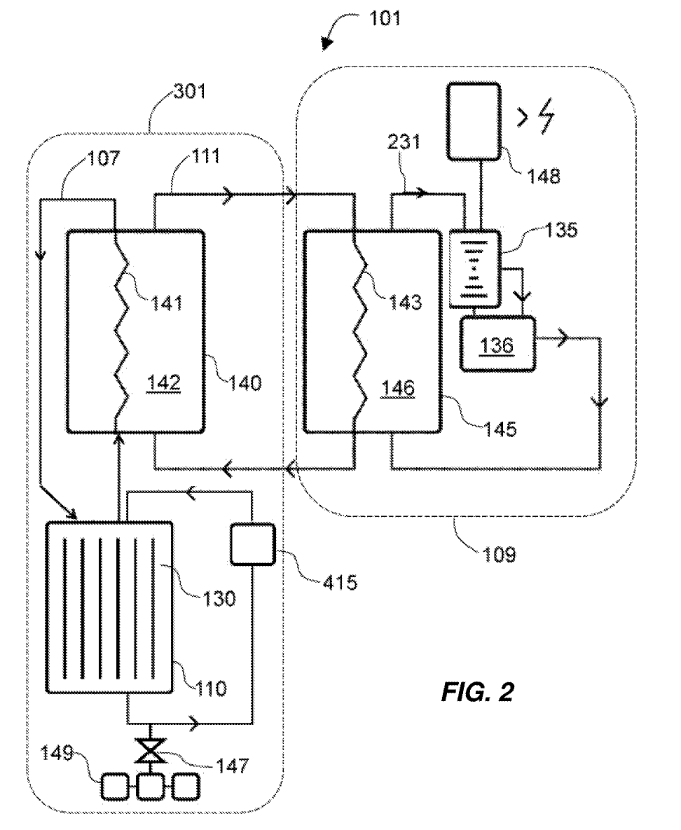

FIG. 2 illustrates an embodiment of a reactor system 101 capable of generating electrical energy using embodiments of the salt compositions discussed above. The reactor system 101 can include a nuclear thermal generator plant (NTGP) 301 and a power conversion system 109 (e.g. heat to electricity conversion). The NTGP 301 includes a molten salt reactor core 110. A salt composition 130 flows between the reactor core 110 and a primary heat exchanger 140 via a primary fluid loop 107. As discussed above, the salt composition 130 can include chloride salts or chloride/fluoride salts. In certain embodiments, the salt composition 130 includes carrier salts that include NaCl and CaCl₂ or NaCl, NaF, CaCl₂, and CaF₂. The salt composition 130 flows into the reactor core 110.

Upon absorbing neutrons, nuclear fission can be initiated and sustained in the salt composition 130 (e.g., fissile molten salt) that is contained within the reactor core 110. The fission process generates heat that elevates the temperature of the salt composition 130 and the temperature of the salt composition can reach approximately 650° C. (1,200° F.). The heated salt composition 130 can be transported through the primary fluid loop 107 via a pump (not shown) from the reactor core 110 to the primary heat exchanger 140, which is configured to transfer the heat of the salt composition 130 to the power conversion system 109.

The transfer of heat from the salt composition 130 can be realized in various ways. For example, the primary heat exchanger 140 can include a plurality of pipes 141 through which the heated salt composition 130 travels. An intermediate working fluid 142 can further surround the pipes 141 and absorb heat from the salt composition 130. Upon heat transfer, the temperature of the salt composition 130 in the primary heat exchanger 140 is reduced and the cooled (but still molten) salt composition 130 is transported back to the reactor core 110. The intermediate working fluid 142 carries the heat to the power conversion system 109 via an intermediate working fluid loop 111.

Any suitable power conversion system 109 can be connected to the NTGP 301. In the embodiment of FIG. 2, the power conversion system 109 is an electrical power plant that transfers the heat via a tertiary fluid 146 through a tertiary fluid loop 231 to a turbine 135. In the depicted embodiment, a secondary heat exchanger 145 transfers heat from the intermediate working fluid 142 to the tertiary fluid 146 as the intermediate working fluid 142 is circulated through the secondary heat exchanger 145 via a plurality of pipes 143. The tertiary fluid 146 in the secondary heat exchanger 145 is heated to a gas and transported to a turbine 135 via the tertiary fluid loop 231. For example, assuming the tertiary fluid 146 is liquid water, the tertiary fluid 146 is converted to steam in the secondary heat exchanger 145. The turbine 135 is turned by the steam and drives an electrical generator 148 to produce electricity. Steam from the turbine 135 is condensed and pumped back to the secondary heat exchanger 145 as liquid water. A supply of liquid water can be stored in a reservoir or tank 136.

Alternatively or additionally, the heat received from the salt composition 130 can be used in other applications such as nuclear propulsion (e.g., marine propulsion), desalination, domestic or industrial heating, hydrogen production, etc., or a combination thereof. The heat that is used is provided by the NTGP 301.

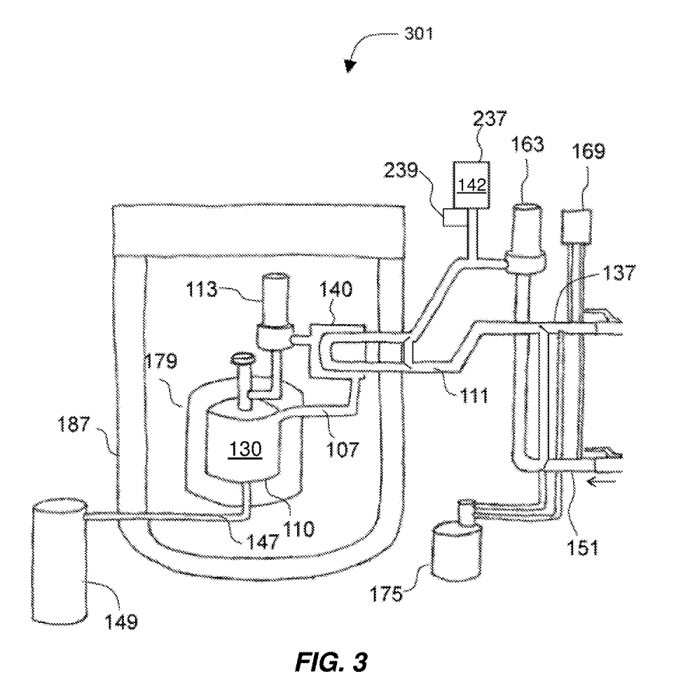

FIG. 3 illustrates an embodiment of the NTGP 301 in greater detail. As discussed above, the NTGP 301 includes the molten salt reactor core 110 in fluid communication with the primary heat exchanger 140 via the primary fluid loop 107. The molten salt reactor core 110 includes the salt composition 130 and a pump 113 can be provided in fluid communication with the primary fluid loop 107 for moving the salt composition 130 through the primary fluid loop 107. The intermediate working fluid loop 111 extends through the primary heat exchanger 140 and is in thermal communication with the primary fluid loop 107. An output manifold 137 and an input manifold 151 are coupled to the power conversion system 109.

The NTGP 301 can also include a gamma and neutron shield 179 surrounding the molten salt reactor core 110. The molten salt reactor core 110 and the primary heat exchanger 140 can be housed in a containment vessel 187 (e.g., a concrete and capped structure) built into the ground or heavily reinforced. One or more drain tanks 149 can be preferably connected to the molten salt reactor core 110 through a freeze plug 147. The freeze plug 147 can be configured to melt in the event that the temperature of the molten salt exceeds a selected value, draining the salt from the molten salt reactor core 110 and into the drain tanks 149 by gravity.

A start-up system can optionally be included within the NTGP 301. The start-up system can include one or more of an intermediate working fluid reservoir 237, a pump 163, and a heating system 239, as well as a plurality of valves and shunts (not shown). The intermediate working fluid reservoir 237 can contain intermediate working fluid 142 in a sufficient volume to ensure that the intermediate working fluid loop 111 remains substantially filled for all temperature conditions. The heating system 239 can be configured to heat the intermediate working fluid 142 to an appropriate viscosity and/or a temperature sufficient to melt the salt composition 130. A pump 163 can be configured to drive the intermediate working fluid 142 through the pipes and shunts. A controller 169 can control flow of an inert gas (e.g., argon or a noble gas) to pipes that make up the start-up system. The start-up system can also include a reservoir tank 175 as a failsafe drainage device configured to receive the intermediate working fluid 142 in the event of an emergency.

During the operation of the molten salt reactor core 110, fission products will be generated in the salt composition 130. The fission products can include a range of elements. In an embodiment, the fission products can include, but are not limited to, rubidium (Rb), strontium (Sr), cesium (Cs), barium (Ba), lanthanides, palladium (Pd), ruthenium (Ru), silver (Ag), molybdenum (Mo), niobium (Nb), antimony (Sb), technetium (Tc), xenon (Xe), and krypton (Kr), alone or in combination.

The buildup of fission products (e.g., radioactive noble metals and radioactive noble gasses) in the salt composition 130 can impede or interfere with the nuclear fission in the reactor core 110 by poisoning the nuclear fission. For example, ¹³⁵Xe and ¹⁴⁹Sm have a high neutron absorption capacity and can lower the reactivity of the salt composition 130. Fission products can also reduce the useful lifetime of the reactor core 110 by clogging components, such as heat exchangers or piping.

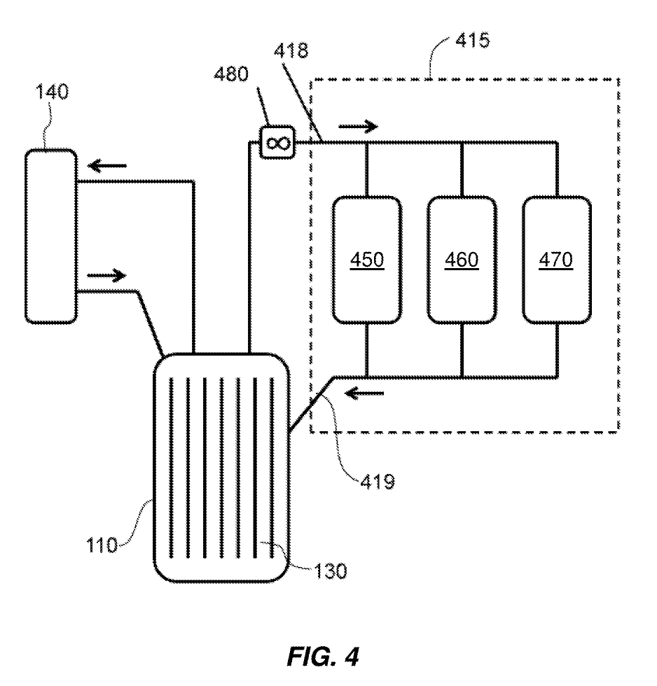

In order to maintain proper functioning of the reactor core 110, it can be desirable to keep concentrations of fission products below certain thresholds in the salt composition 130. This can be accomplished by a chemical processing plant 415 in fluid communication with the reactor core 110, as illustrated in FIG. 4. The chemical processing plant 415 can be configured to remove at least a portion of fission products generated in the salt composition 130 during nuclear fission, while retaining the actinides in the salt composition 130. During operation, the salt composition 130 is transported from the molten salt reactor core 110 to the chemical processing plant 415. In the chemical processing plant 415, the salt composition 130 can be processed so that the molten salt reactor core 110 functions without loss of efficiency or degradation of components.

As shown in FIG. 4, the chemical processing plant 415 can include a corrosion reduction unit 450, a filtration unit 460, and a salt exchange unit 470 fed by a delivery line 418 and a return line 419. The salt composition 130 can be circulated continuously (or near-continuously) from the molten salt reactor core 110 through the chemical processing plant 415 (e.g., over the delivery line 418 and the return line 419) by way of a pump 480.

The corrosion reduction unit 450 can be configured to reduce or limit corrosion of the NTGP 301 (e.g., the molten salt reactor core 110, the pump 113, the primary heat exchanger 140, etc.) by the salt composition 130. In general, the reactor core 110 can be constructed of metallic alloy including one or more of the following elements: iron (Fe), nickel (Ni), chromium (Cr), manganese (Mn), carbon (C), silicon (Si), niobium (Nb), aluminum (Al), titanium (Ti), vanadium (V), phosphorus (P), sulfur (S), molybdenum (Mo) or nitrogen (N). As discussed in detail below, the corrosion reduction unit 450 can operate to control a level of uranium tetrachloride (UCl₄) within the salt composition, which can result in corrosion of the reactor core 110 by facilitating oxidation of the metallic alloy(s) of the reactor core 110 (e.g. Cr→Cr³⁺+3e−; Cr+3UCl₄→CrCl₃+3UCl₃). However, generation of other compounds leading to corrosion of the structural components of the reactor core 110 can be generated during operation.

During operation of the reactor core 110 (e.g., performing nuclear fission), the salt composition 130 is transported from the molten salt reactor core 110 to the corrosion reduction unit 450 and from the corrosion reduction unit 450 back to the molten salt reactor core 110. The transportation of the salt composition 130 can be driven by the pump 480 which can be configured to adjust the rate of transportation. The corrosion reduction unit 450 can be configured to process the salt composition 130 to maintain an oxidation-reduction (redox) ratio, E(o)/E(r), in the salt composition 130 in the molten salt reactor core 110 (and elsewhere throughout the reactor system 101) at a substantially constant level, where E(o) is an element (E) at a higher oxidation state and E(r) is the element at a lower (reduced) oxidation state . In an embodiment, the element (E) can be an actinide (e.g., uranium, U). Thus, E(o) can be an oxidized form of the actinide (e.g., U(IV)) and E(r) can be a reduced form of the actinide (e.g., U(III)). In this example, U(IV) can be in the form of uranium tetrachloride (UCl₄), U(III) can be in the form of uranium trichloride (UCl₃), and the redox ratio is the ratio E(o)/E(r) of UCl₄/UCl₃. Although UCl₄ can result in corrosion of the reactor system 101 (e.g., the molten salt reactor core 110, pump 113, primary heat exchanger 140, etc.), the existence of UCl₄ can reduce the melting point of the salt composition 130. Therefore, the level of the redox ratio, UCl₄/UCl₃, can be selected based on a desired corrosion reduction and a desired melting point of the salt composition 130. For example, in an embodiment, the redox ratio can a substantially constant ratio selected from the range of about 1/50 to about 1/2000. In further embodiments, the redox ratio can selected at a substantially constant level of about 1/2000.

The filtration unit 460 can be configured to remove at least part of the insoluble fission products from the salt composition 130. Examples of the insoluble fission products can include, but are not limited to, one or more of krypton (Kr), xenon (Xe), palladium (Pd), ruthenium (Ru), silver (Ag), molybdenum (Mo), niobium (Nb), antimony (Sb), and technetium (Tc). The filtration unit 460 can also configured to remove at least part of fission product gasses dissolved in the salt composition. Examples of the dissolved fission product gases can include, but are not limited to, xenon (Xe) and krypton (Kr).

The salt exchange unit 470 can be configured to remove at least a portion of the soluble fission products from the salt composition 130 to waste. Examples of the soluble fission products can include, but are not limited to, rubidium (Rb), strontium (Sr), cesium (Cs), barium (Ba), and elements selected from lanthanides. The salt exchange unit 470 can also be configured to return any actindes that may have been removed by the salt exchange unit 470 to the salt composition 130.

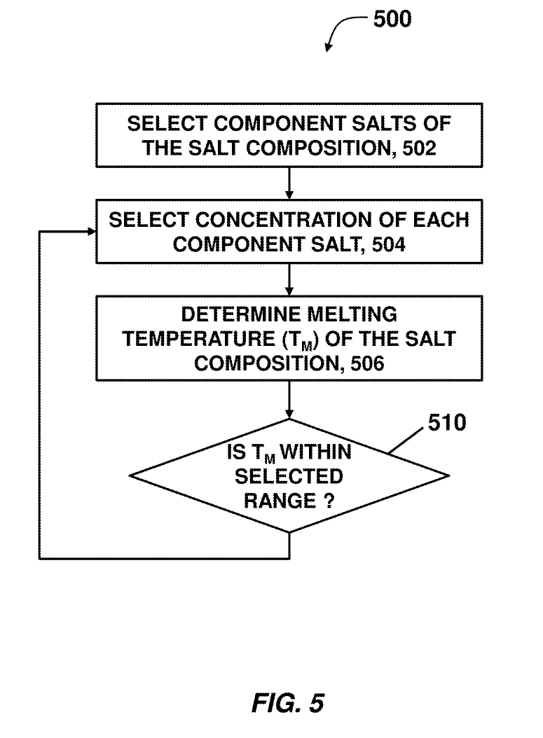

FIG. 5 is a flow diagram illustrating an embodiment of a method 500 for preparing the salt composition 130 having a melting temperature within a selected range for use as a nuclear fuel. The method 500 can include operations 502-510. As shown in FIG. 5, the salts of the composition can be selected in operation 502. The chosen salt composition can include any salt composition 130 as discussed above. In operation 504, the concentration of each component of the salt composition can be selected. In operation 506, the melting temperature of the composition can be determined. For example, the component salts can be mixed in the selected concentrations to form the salt composition 130 and the melting temperature of the salt composition 130 can be measured. Alternatively, the melting temperature can be derived theoretically or inferred from empirical measurements. In operation 510, a determination can be made whether the combination of selected salts having the respective selected concentrations possesses a melting temperature within a selected range. If so, the method 500 can conclude with operation 510. If not, the method 500 can return to operation 504, where one or more concentrations of the components of the salt composition can be changed.

Fission products applicable to the systems and methods described herein follow below. The listed fission products are provided for illustration and not meant to be exhaustive.

Fission products sufficiently noble to maintain a reduced and insoluble state in embodiments of the salt composition 130 can include:
Germanium-72, 73, 74, 76
Arsenic-75
Selenium-77, 78, 79, 80, 82
Yttrium-89
Zirconium-90 to 96
Niobium-95
Molybdenum-95, 97, 98, 100
Technetium-99
Ruthenium-101 to 106
Rhodium-103
Palladium-105 to 110
Silver-109
Cadmium-111 to 116
Indium-115
Tin-117 to 126
Antimony-121, 123, 124, 125
Tellurium-125 to 132

Fission products that can form gaseous products at the operating temperatures of the reactor core 110 can include:
Bromine-81
Iodine-127, 129, 131
Xenon-131 to 136
Krypton-83, 84, 85, 86

Fission products that can remain in the salt composition 130 as chloride compounds or mixtures of chloride and fluoride compounds in addition to actinide chlorides (e.g., Th, Pa, U, Np, Pu, Am, Cm) and carrier salt chlorides and chlorides/fluorides (e.g., Na, K, Ca) can include:
Rubidium-85, 87
Strontium-88, 89, 90
Cesium-133, 134, 135, 137
Barium-138, 139, 140
Lanthanides (lanthanum-139, cerium-140 to 144, praseodymium-141, 143, neodymium-142 to 146, 148, 150, promethium-147, samarium-149, 151, 152, 154, europium-153, 154, 155, 156, Gadolinium-155 to 160, Terbium-159, 161, and Dysprosium-161)

### STATEMENTS REGARDING INCORPORATION BY REFERENCE AND VARIATIONS

All references cited throughout this application, for example patent documents including issued or granted patents or equivalents, patent application publications, and non-patent literature documents or other source material, are hereby incorporated by reference herein in their entireties, as though individually incorporated by reference, to the extent each reference is at least partially not inconsistent with the disclosure in this application. For example, a reference that is partially inconsistent is incorporated by reference except for the partially inconsistent portion of the reference.

One of ordinary skill in the art will appreciate that starting materials, biological materials, reagents, synthetic methods, purification methods, analytical methods, assay methods, and biological methods other than those specifically exemplified can be employed in the practice of embodiments of the disclosure without resort to undue experimentation. All art-known functional equivalents, of any such materials and methods are intended to be included in the disclosed embodiments.

When a group of substituents is disclosed herein, it is understood that all individual members of that group and all subgroups, including any isomers, enantiomers, and diastereomers of the group members, are disclosed separately.

When a Markush group, or other grouping is used herein, all individual members of the group and all combinations and sub-combinations possible of the group are intended to be individually included in the disclosure.

When a compound is described herein such that a particular isomer, enantiomer, or diastereomer of the compound is not specified, for example, in a formula or in a chemical name, that description is intended to include each isomers and enantiomer of the compound described individual or in any combination. Additionally, unless otherwise specified, all isotopic variants of compounds disclosed herein are intended to be encompassed by the disclosure. For example, it will be understood that any one or more hydrogens in a molecule disclosed can be replaced with deuterium or tritium. Isotopic variants of a molecule are generally useful as standards in assays for the molecule and in chemical and biological research related to the molecule or its use. Methods for making such isotopic variants are known in the art. Specific names of compounds are intended to be exemplary, as it is known that one of ordinary skill in the art can name the same compounds differently.

As used herein, and in the appended claims, the singular forms “a,” “an,” and “the” include plural reference unless the context clearly dictates otherwise. Thus, for example, reference to “a cell” includes a plurality of such cells and equivalents thereof known to those skilled in the art, and so forth. Additionally, the terms “a” (or “an”), “one or more” and “at least one” can be used interchangeably herein.

As used herein, the term “comprising” is synonymous with “including,” “having,” “containing,” and “characterized by” and each can be used interchangeably. Each of these terms is further inclusive or open-ended and do not exclude additional, unrecited elements or method steps.

As used herein, the term “consisting of” excludes any element, step, or ingredient not specified in the claim element.

As used herein, the term “consisting essentially of” does not exclude materials or steps that do not materially affect the basic and novel characteristics of the claim. In each instance herein any of the terms “comprising”, “consisting essentially of,” and “consisting of” may be replaced with either of the other two terms.

The embodiments illustratively described herein suitably may be practiced in the absence of any element or elements, limitation or limitations which is not specifically disclosed herein.

The expression “of any of claims XX-YY” (where XX and YY refer to claim numbers) is intended to provide a multiple dependent claim in the alternative form and in some embodiments can be interchangeable with the expression “as in any one of claims XX-YY.”

Unless defined otherwise, all technical and scientific terms used herein have the same meanings as commonly understood by one of ordinary skill in the art to which the disclosed embodiments belong.

Whenever a range is given in the specification, for example, a temperature range, a time range, a composition range, or a concentration range, all intermediate ranges and sub-ranges, as well, as all individual values included in the ranges given, are intended to be included in the disclosure. As used herein, ranges specifically include the values provided as endpoint values of the range. For example, a range of 1 to 100 specifically includes the end point values of 1 and 100. It will be understood that any subranges or individual values in a range or sub-range that are included in the description herein can be excluded from the claims herein.

In the descriptions above and in the claims, phrases such as “at least one of” or “one or more of” may occur followed by a conjunctive list of elements or features. The term “and/or” may also occur in a list of two or more elements or features. Unless otherwise implicitly or explicitly contradicted by the context in which it is used, such a phrase is intended to mean any of the listed elements or features individually or any of the recited elements or features in combination with any of the other recited elements or features. For example, the phrases “at least one of A and B;” “one or more of A and B;” and “A and/or B” are each intended to mean “A alone, B alone, or A and B together.” A similar interpretation is also intended for lists including three or more items. For example, the phrases “at least one of A, B, and C;” “one or more of A, B, and C;” and “A, B, and/or C” are each intended to mean “A alone, B alone, C alone, A and B together, A and C together, B and C together, or A and B and C together.” In addition, use of the term “based on,” above and in the claims is intended to mean, “based at least in part on,” such that an unrecited feature or element is also permissible.

The terms and expressions which have been employed herein are used as terms of description and not of limitation, and there is no intention in the use of such terms and expressions of excluding any equivalents of the features shown and described or portions thereof, but it is recognized that various modifications are possible within the scope of the claimed embodiments. Thus, it should be understood that although the present application may include discussion of preferred embodiments, exemplary embodiments and optional features, modification and variation of the concepts herein disclosed may be resorted to by those skilled in the art. Such modifications and variations are considered to be within the scope of the disclosed embodiments, as defined by the appended claims. The specific embodiments provided herein are examples of useful embodiments of the present disclosure and it will be apparent to one skilled in the art that they may be carried out using a large number of variations of the devices, device components, and methods steps set forth in the present description. As will be obvious to one of skill in the art, methods and devices useful for the present methods can include a large number of optional compositions and processing elements and steps.

What is claimed is:

1. A composition comprising:
a carrier salt comprising at least one chloride salt of an alkali or alkaline earth metal; and
a fuel salt comprising at least one chloride salt of an actinide;
wherein the concentration of the fuel salt is selected from the range of about 20 mole % to about 70 mole % of the composition and wherein the composition has a melting temperature less than or equal to 600° C.

2. The composition of claim 1, wherein the carrier salt comprises NaCl and CaCl₂.

3. The composition of claim 1, wherein the fuel salt comprises UCl₃.

4. The composition of claim 3, wherein the fuel salt further comprises PuCl₃.

5. The composition of claim 4, wherein the fuel salt further comprises ThCl₄.

6. The composition of claim 5 wherein the fuel salt further comprises one or more of PaCl₄, UCl₄, NpCl₃, AmCl₃, and CmCl₃.

7. The composition of claim 3, wherein the carrier salt comprises NaCl and CaCl₂.

8. The composition of claim 7, comprising NaCl in a concentration selected from the range of about 40 mole % to about 80 mole %.

9. The composition of claim 8, comprising NaCl in a concentration selected from the range of about 50 mole % to about 60 mole %.

10. The composition of claim 7, comprising CaCl₂ in a concentration selected from the range of about 1 mole % to about 40 mole %.

11. The composition of claim 10, comprising CaCl₂ in a concentration selected from the range of about 5 mole % to about 30 mole %.

12. The composition of claim 7, comprising the fuel salt in a concentration selected from the range of about 20 mole % to about 50 mole %.

13. The composition of claim 1, comprising:
NaCl in a concentration selected from the range of about 50 mole % to about 60 mole %;
CaCl₂ in a concentration selected from the range of about 5 mole % to about 30 mole %;
at least one actinide tri-chloride selected from the group consisting of: AmCl₃, CmCl₃, NpCl₃, PuCl₃, and UCl₃, wherein the total concentration of actinide tri-chlorides is selected from the range of about 40 mole % to about 60 mole %; and
at least one actinide tetra-chloride selected from the group consisting of: UCl₄, PaCl₄, and ThCl₄, wherein the total concentration of actinide tetra-chlorides is selected from the range of about 2 mole % to about 10 mole %.

14. The composition of claim 1, wherein the melting temperature of the composition is between about 325° C. and about 500° C.

15. The composition of claim 1, further comprising a plurality of metal halide phase modifiers.

16. The composition of claim 15, wherein the plurality of metal halides are selected from the group consisting of: NbCl₅, TiCl₄, ZnCl₂, YCl₃, ZrCl₄, and AlCl₃.

17. The composition of claim 15, wherein the total concentration of the phase modifier is selected from the range of about 1 mole % to about 20 mole %.

18. A composition comprising:
a carrier salt comprising a mixture of at least one chloride salt of an alkali or alkaline earth metal and at least one fluoride salt of an alkali or alkaline earth metal; and
a fuel salt comprising at least one chloride salt of an actinide;
wherein the concentration of the fuel salt is selected from the range of about 20 mole % to about 70 mole % of the composition and wherein the composition has a melting temperature less than or equal to 600° C.

19. The composition of claim 18, wherein the carrier salt comprises NaCl, NaF, CaCl₂, and CaF₂.

20. The composition of claim 18, wherein the fuel salt comprises UCl₃.

21. The composition of claim 20, wherein the fuel salt further comprises PuCl₃.

22. The composition of claim 21, wherein the fuel salt further comprises ThCl₄.

23. The composition of claim 22, wherein the fuel salt further comprises one or more of PaCl₄, UCl₄, NpCl₃, AmCl₃, and CmCl₃.

24. The composition of claim 20, wherein the carrier salt comprises NaCl, NaF, CaCl₂, and CaF₂.

25. The composition of claim 24, comprising NaCl and NaF in a total concentration selected from the range of about 40 mole % to about 80 mole %.

26. The composition of claim 25, comprising CaCl₂ and CaF₂ in a total concentration selected from the range of about 50 mole % to about 60 mole %.

27. The composition of claim 24, comprising NaCl and NaF in a total concentration selected from the range of about 1 mole % to about 40 mole %.

28. The composition of claim 27, comprising CaCl₂ and CaF₂ in a total concentration selected from the range of about 5 mole % to about 30 mole %.

29. The composition of claim 28, comprising the fuel salt in a concentration selected from the range of about 20 mole % to about 50 mole %.

30. The composition of claim 18, comprising:
NaCl and NaF in a total concentration selected from the range of about 20 mole % to about 40 mole %;
CaCl₂ and CaF₂ in a total concentration selected from the range of about 10 mole % to about 30 mole %;
at least one actinide tri-chloride selected from the group consisting of: AmCl₃, CmCl₃, NpCl₃, PuCl₃, and UCl₃, wherein the total concentration of actinide tri-chlorides is selected from the range of about 40 mole % to about 60 mole %; and
at least one actinide tetra-chloride selected from the group consisting of: UCl₄, PaCl₄, and ThCl₄, wherein the total concentration of actinide tetra-chlorides is selected from the range of about 2 mole % to about 10 mole %.

31. The composition of claim 18, wherein the melting temperature of the composition is between about 325° C. and about 500° C.

32. The composition of claim 18, further comprising a plurality of metal halide phase modifiers.

33. The composition of claim 32, wherein the plurality of metal halides are selected from the group consisting of: NbCl₅, TiCl₄, ZnCl₂, YCl₃, ZrCl₄, and AlCl₃.

34. The composition of claim 32, wherein the total concentration of the phase modifiers is selected from the range of about 1 mole % to about 20 mole %.
